(19) United States
(12) Patent Application Publication
(10) Pub. No.: US 2006/0212228 A1
(43) Pub. Date: Sep. 21, 2006

(54) Identification-data setting device, identification-data setting method, and computer product

(75) Inventors: Atsuhiro Otaka, Kawasaki (JP); Daiya Nakamura, Kawasaki (JP); Oumar Thielo, Kawasaki (JP)

Correspondence Address: STAAS & HALSEY LLP, SUITE 700, 1201 NEW YORK AVENUE, N.W., WASHINGTON, DC, 20005, US

(73) Assignee: FUJITSU LIMITED, Kawasaki (JP)

(21) Appl. No.: 11/168,441

(22) Filed: Jun. 29, 2005

(30) Foreign Application Priority Data
Mar. 16, 2005 (JP) 2005-075728

(51) Int. Cl. G06F 19/00

(52) U.S. Cl. 702/19

(57) ABSTRACT

A device for setting identification information for identifying an intermediary device mounted on a substrate, the device includes an information acquiring unit that acquires position information indicating a position at which the intermediary device is mounted; and an information setting unit that sets the identification information based on the position information.

### BACKGROUND OF THE INVENTION

1. Field of the Invention

The present invention relates to a technology for setting identification information for an intermediary device in a redundant-arrays-of-independent-disk (RAID) system.

2. Description of the Related Art

A technology for connecting a main unit of a computer and storage devices using a data transfer method such as fiber channeling is conventionally used (for example, Japanese Patent Application Laid Open No. 2001-14261). In such data transfer method, an address is used to indicate where the storage devices are connected to through an intermediary device. The address includes identification information such as a switch-identification (ID) to identify a fiber channel switch that is the intermediary device, a switch-port-number to identify a port through which the fiber channel switch and a disk device are connected, and an arbitrated loop physical address (AL_PA) to identify a disk in the disk device connected to the port. The switch-port-number and the AL_PA are automatically set according to specifications. However, the switch-ID is required to be set manually by a user.

Accordingly, in the conventional technology, the identification information of the intermediary device is manually set by the user. Since the identification information is required to be unique, excessive time and work is required of the user.

### SUMMARY OF THE INVENTION

It is an object of the present invention to at least solve the problems in the conventional technology.

A device for setting identification information according to one aspect of the present invention is for identifying an intermediary device mounted on a substrate, and includes an information acquiring unit that acquires position information indicating a position at which the intermediary device is mounted; and an information setting unit that sets the identification information based on the position information.

A method of setting identification information according to another aspect of the present invention is for identifying an intermediary device mounted on a substrate, and includes acquiring position information indicating a position at which the intermediary device is mounted; and setting the identification information based on the position information.

A computer-readable recording medium according to still another aspect of the present invention stores a computer program for realizing a method according to the above aspect.

The other objects, features, and advantages of the present invention are specifically set forth in or will become apparent from the following detailed description of the invention when read in conjunction with the accompanying drawings.

### BRIEF DESCRIPTION OF THE DRAWINGS

FIG. 1 is a schematic of a RAID device;

FIG. 2 is a schematic of a switch according to a first embodiment of the present invention;

FIG. 3 is a block diagram of the switch shown in FIG. 2;

FIG. 4 is a mounting-position table stored in a memory shown in FIG. 3;

FIG. 5 is a flowchart of an identification-information setting process according to the first embodiment; and

FIG. 6 is a schematic for illustrating a switch according to a second embodiment of the present invention.

### DETAILED DESCRIPTION OF THE PREFERRED EMBODIMENTS

Exemplary embodiments of the present invention are explained in detail below with reference to the accompanying drawings. The present invention is not limited to these embodiments.

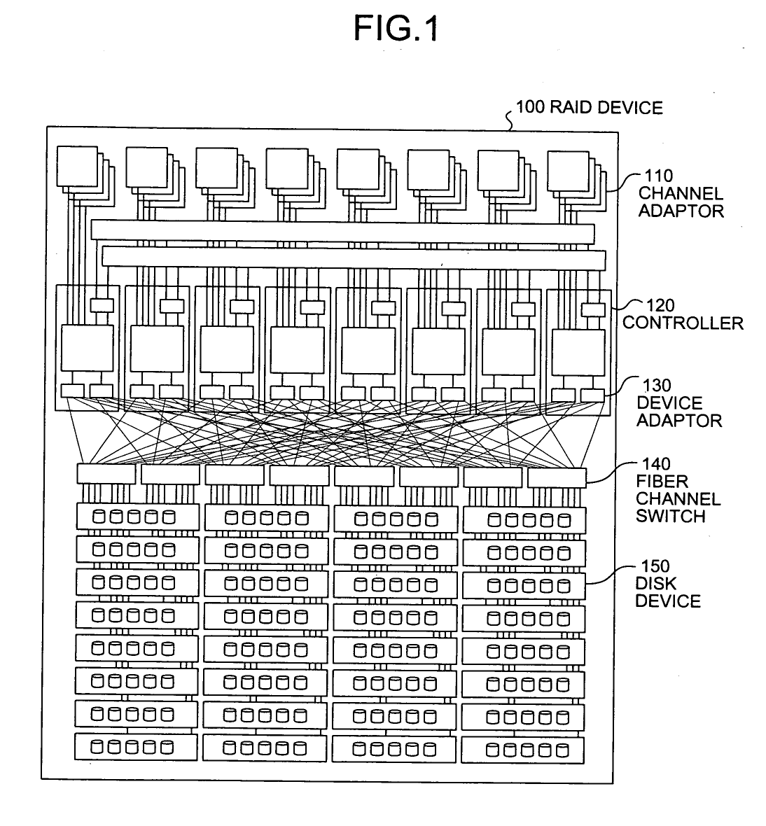

FIG. 1 is a block diagram of a RAID device 100 according to a first embodiment of the present invention. As shown in FIG. 1, the RAID device 100 includes channel adaptors 110, controllers 120, device adaptors 130, fiber channel switches 140, and disk devices 150. The fiber channel switches 140 are intermediary devices.

The RAID device 100 typically connects a computer and the disk devices 150 using a data transfer method such as the fiber channeling. One of the disk devices 150 is connected through one of the fiber channel switches 140. In such data transfer method, an address is used to indicate where the disk device 150 is connected to. For example, the address includes a switch-ID to identify the fiber channel switch 140, a switch-port-number to identify a port through which the fiber channel switch 140 and the disk device 150 are connected, and an AL_PA to identify a disk in the disk device 150 connected to the port. The fiber channel switch 140 includes an address table that includes addresses and corresponding positions in the disk device 150. When an access command is received from a server, the fiber channel switch 140 refers to the address table to specify a position in the disk device 150, and accesses the position.

Among the addresses, the switch-port-number and the AL_PA are automatically set according to specifications. However, a switch-ID is required to be set manually by a user in conventional cases. In the present invention, the switch-ID is also set automatically.

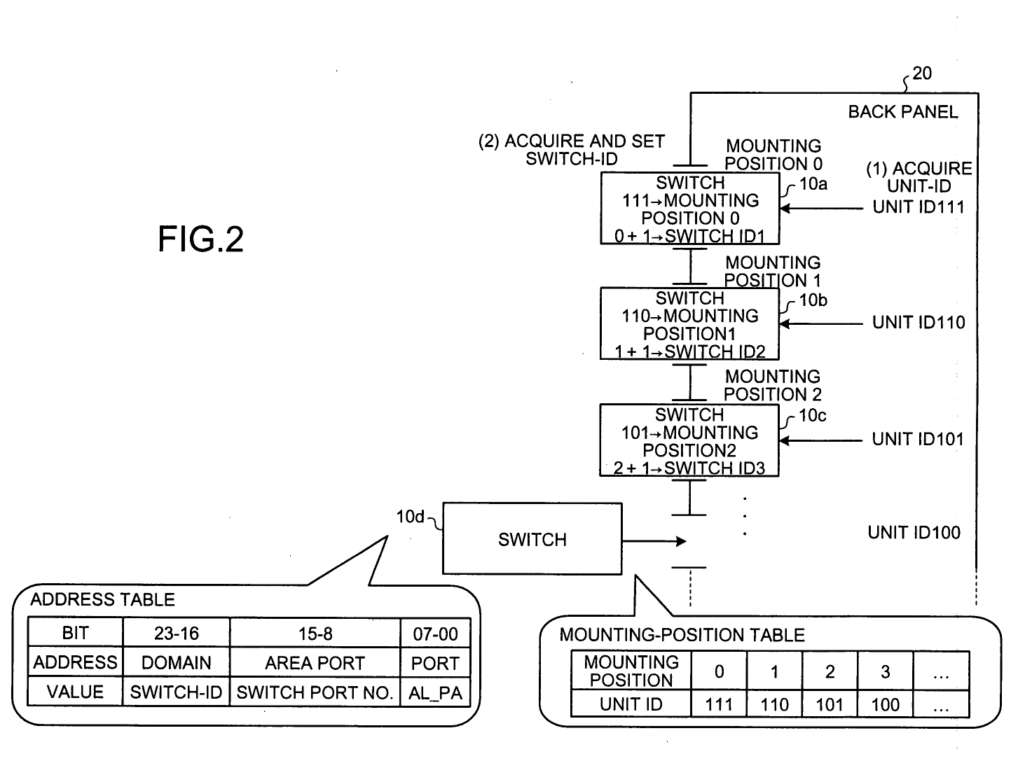

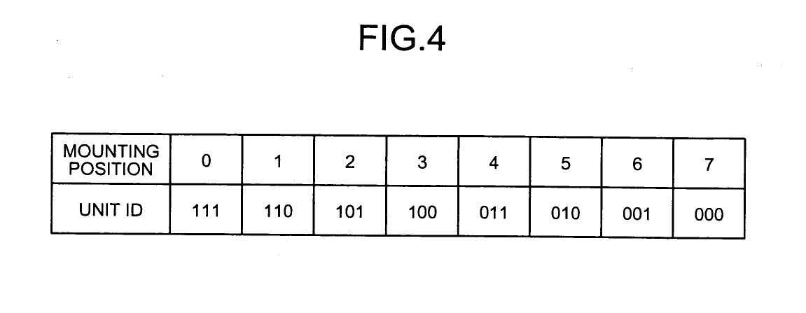

FIG. 2 is a schematic of a switch according to the first embodiment of the present invention. Switches 10a to 10d are mounted on a back panel 20. Each of the mounting positions on the back panel 20 has a unique unit-ID. Each of the switches 10a to 10d includes the mounting-position table as shown in FIG. 4. When the switch is mounted on the back panel 20, the switch acquires the unit-ID of the corresponding mounting position from the back panel 20, refers to the mounting-position table, and acquires a position number that indicates the corresponding mounting position. Each of the switches 10a to 10d adds “1” to the position number acquired, and sets the number thus obtained as its own switch-ID.

For example, when the switch 10a is mounted on a mounting position “0” on the back panel 20, a unit-ID “111” is acquired from the back panel 20. The switch 10a refers to the mounting-position table, acquires a mounting position number “0” corresponding to the unit-ID “111”, adds “1” to “0” to obtain “1”, and sets “1” as the switch-ID in the address table. Because different switch-IDs are set automatically, a user is not required to spend extra time and work.

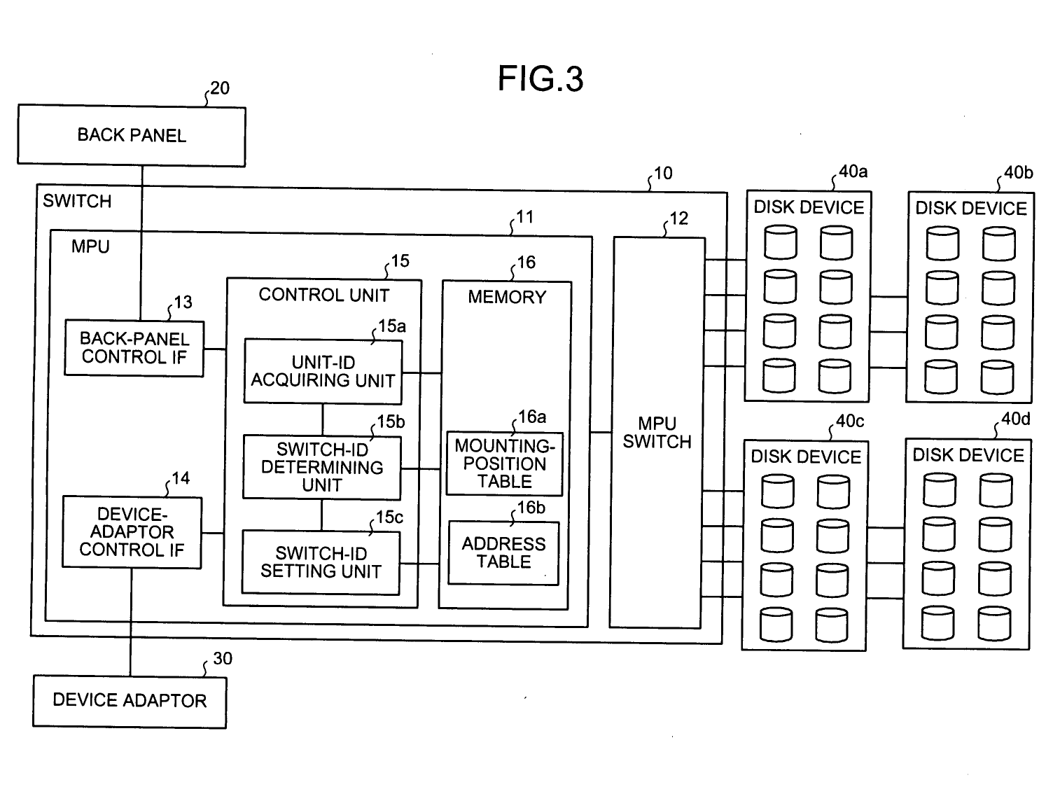

FIG. 3 is a block diagram of a switch 10 according to the first embodiment. The switch 10 is connected, through busses to the back panel 20, a device adaptor 30, and a disk device 40.

The switch 10 includes a micro processing unit (MPU) 11 and an MPU switch 12. The MPU switch 12 functions as a conventional switch.

On the other hand, the MPU 11 includes a back-panel control interface (IF) 13, a device-adaptor control IF 14, a control unit 15, and a memory 16.

The back-panel control IF 13 controls data transfer related to unit-IDs between the switch 10 and the back panel 20. The device-adaptor control IF 14 controls various data transfer between the switch 10 and the device adaptor 30.

The memory 16 stores data and programs required for various processings performed by the control unit 15, including a mounting-position table 16a and an address table 16b.

The mounting-position table 16a stores position numbers of mounting positions on the back panel 20, and corresponding unit-IDs, as shown in FIG. 4. The address table 16b stores addresses and corresponding positions in the disk device 40.

The control unit 15 includes an internal memory, and executes various processings based on programs and data, including a unit-ID acquiring unit 15a, a switch-ID determining unit 15b, and a switch-ID setting unit 15c, that are stored in the internal memory.

The unit-ID acquiring unit 15a acquires a unit-ID from the back panel 20. Specifically, when the switch 10 is mounted on the back panel 20, the unit-ID acquiring unit 15a acquires the unit-ID of the mounting position. Referring to FIG. 2, when the switch 10a is mounted on the mounting position “0”, the unit-ID acquiring unit 15a acquires the unit-ID “111” that corresponds to the mounting position “0”. When a switch 10b is mounted on a mounting position “1”, the unit-ID acquiring unit 15a acquires a unit-ID “110” that corresponds to the mounting position “1”.

The switch-ID determining unit 15b determines a switch-ID from the unit-ID acquired by the unit-ID acquiring unit 15a. Specifically, the switch-ID determining unit 15b refers to the mounting-position table 16a, reads a position number corresponding to the unit-ID acquired, adds “1” to the position number, and determines a number thus obtained as the switch-ID. For example, when the unit-ID acquiring unit 15a acquires the unit-ID “111”, the switch-ID determining unit 15b reads, from the mounting-position table, the mounting position number “0” corresponding to the unit-ID “111”, adds “1” to “0” to obtain “1”, and determines “1” as the switch-ID.

The switch-ID setting unit 15c sets a switch-ID in the address table 16b by writing the switch-ID determined in the address table 16b. Referring to the address table shown in FIG. 2, the switch-ID determined is set as a domain value.

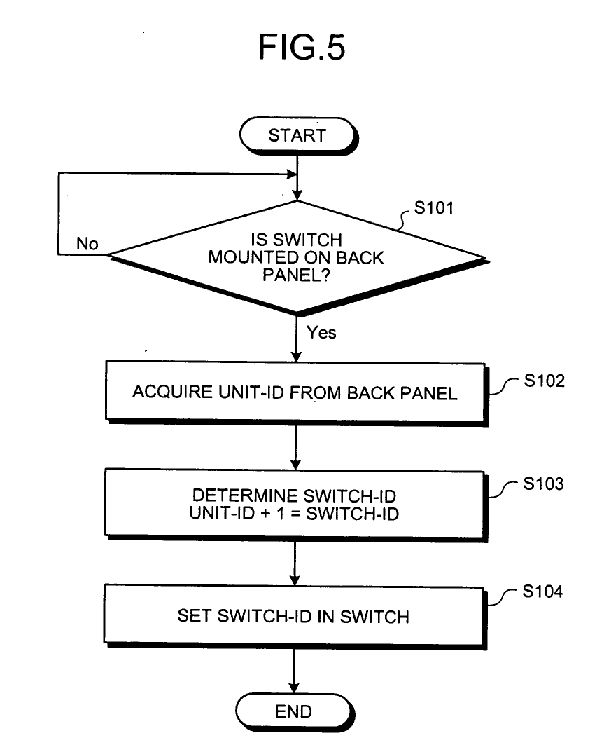

FIG. 5 is a flowchart of an identification-information setting process. When the switch 10 is mounted on the back panel 20 (“YES” at step S101), the unit-ID acquiring unit 15a acquires a unit-ID from the back panel 20 (step S102).

The switch-ID determining unit 15b determines a switch-ID by adding “1” to the unit-ID acquired (step S103), and the switch-ID setting unit 15c writes the switch-ID determined in the address table 16b (step S104).

According to the first embodiment, the switch 10 acquires from the back panel 20 a unit-ID corresponding to a mounting position, and automatically sets a switch-ID based on the unit-ID acquired. Therefore, time and work for setting the switch-ID can be saved.

According to the first embodiment, the switch 10 acquires a unit-ID thereof from the back panel 20, and sets the switch-ID based on the unit-ID acquired. Thus, the switch-ID is easily set without requiring external devices such as a management server.

According to the first embodiment, the switch-IDs reflect the order in which the switches 10 are arranged on the back panel 20. Thus, when an error occurs in one of the switches 10, the position of the switch 10 having the error can be easily identified based on the switch-ID.

According to the first embodiment, a switch-ID is obtained by adding “1” to a position number corresponding to the unit-ID acquired. Accordingly, even when the unit-ID includes “0”, the switch-ID does not include “0”. Therefore, the switch-ID is compatible with specifications that exclude “0”.

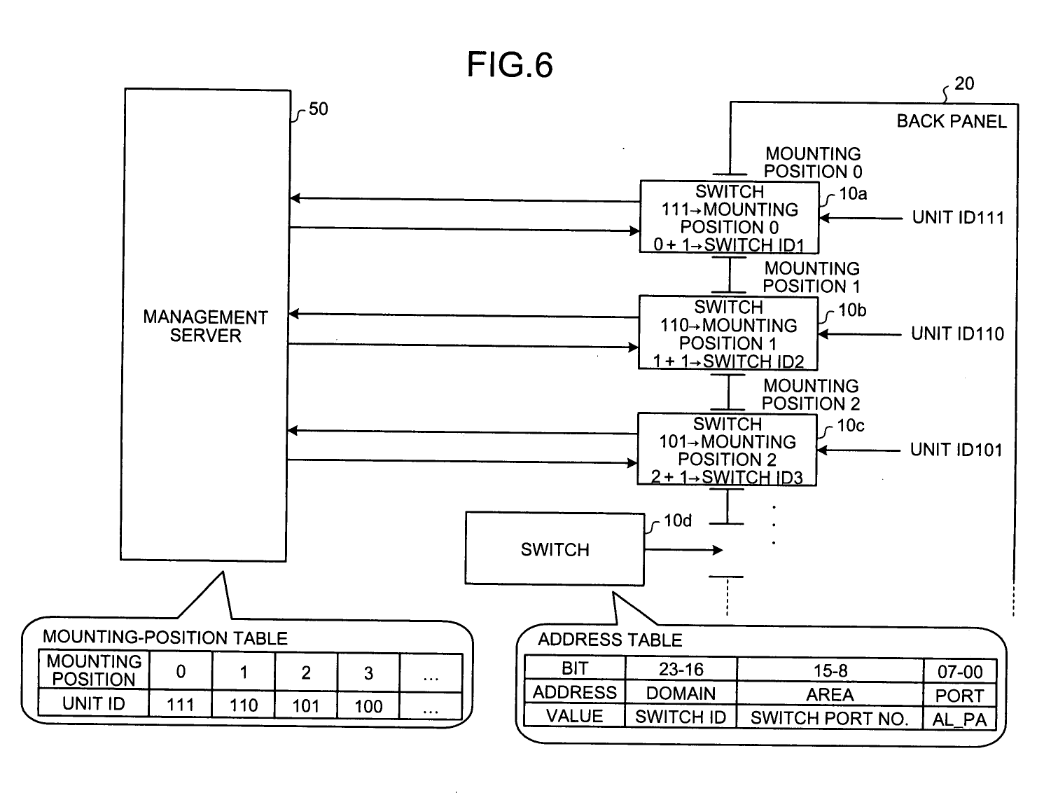

In the first embodiment, the switch 10 acquires a unit-ID of its own, and sets a switch-ID thereof based on the unit-ID acquired. However, as shown in FIG. 6, each of the switches 10a to 10d may send the unit-ID acquired to a management server 50, and the management server 50 may set different switch-IDs for the switches 10a to 10d based on the unit-IDs received.

In the first embodiment, the switch-IDs reflect the order in which the switches 10 are arranged on the back panel 20. However, the switch-IDs may reflect the order in which the switches 10 are mounted on the back panel 20.

Moreover, in the first embodiment, a switch-ID is obtained by adding “1” to the position number corresponding to the unit-ID. However, the position number of the unit-ID may be set as the switch-ID, or any number other than “1” may be added to the position number of the unit-ID to obtain a switch-ID.

Constituent elements, such as the switches, are conceptually illustrated, and may not necessarily physically resemble structures shown in the drawings. A whole or a part of the constituent elements may be broken down or integrated either functionally or physically depending on a load or a condition of use. For example, the switch-ID determining unit 15b and the switch-ID setting unit 15c may be integrated. Each process may be entirely or partially realized by a central processing unit (CPU), a program that is executed by the CPU, or by hardware using wired logic.

Processes explained to be automatically performed in the first embodiment may be manually performed entirely or partially. Similarly, processes explained to be manually performed may be automatically performed entirely or partially by a known method. Moreover, a sequence of processes, a sequence of controls, specific names, and data including various parameters may be changed as required unless otherwise specified.

The identification-information setting method according to the embodiments of the present invention may be implemented by a computer, such as a personal computer (PC) and a workstation, executing a computer program. The computer program may be stored in a computer-readable recording medium such as a read-only memory (ROM), a hard disk (HD), a flexible disk (FD), a compact-disc read-only memory (CD-ROM), a compact disc recordable (CD-R), a compact-disc rewritable (CD-RW), a magneto-optical (MO) disk, a digital versatile disc (DVD). The computer program may be downloaded via a network such as the Internet.

Although the invention has been described with respect to a specific embodiment for a complete and clear disclosure, the appended claims are not to be thus limited but are to be construed as embodying all modifications and alternative constructions that may occur to one skilled in the art which fairly fall within the basic teaching herein set forth.

What is claimed is:

1. A device for setting identification information for identifying an intermediary device mounted on a substrate, the device comprising:
an information acquiring unit that acquires position information indicating a position at which the intermediary device is mounted; and
an information setting unit that sets the identification information based on the position information.

2. The device according to claim 1, wherein
the information acquiring unit and the information setting unit are included in the intermediary device,
the information acquiring unit acquires the position information indicating a position at which the intermediary device itself is mounted, and
the information setting unit that sets the position information at which the intermediary device itself is mounted based on the identification information of the intermediary device itself.

3. The device according to claim 1, wherein
a plurality of intermediary devices are mounted on the substrate, and
the identification information includes information on an order of an arrangement of the intermediary devices.

4. The device according to claim 1, wherein
the position information is represented by a first number, and
the information setting unit sets a second number that is obtained by adding one to the first number as the identification information.

5. A method of setting identification information for identifying an intermediary device mounted on a substrate, the method comprising:
acquiring position information indicating a position at which the intermediary device is mounted; and
setting the identification information based on the position information.

6. The method according to claim 5, wherein
the acquiring and the setting are performed in the intermediary device,
the acquiring includes acquiring the position information indicating a position at which the intermediary device itself is mounted, and
the setting includes setting the position information at which the intermediary device itself is mounted based on the identification information of the intermediary device itself.

7. The method according to claim 5, wherein
a plurality of intermediary devices are mounted on the substrate, and
the identification information includes information on an order of an arrangement of the intermediary devices.

8. The method according to claim 5, wherein
the position information is represented by a first number, and
the setting includes setting a second number that is obtained by adding one to the first number as the identification information.

9. A computer-readable recording medium that stores a computer program for setting identification information for identifying an intermediary device mounted on a substrate, the computer program making a computer execute:
acquiring position information indicating a position at which the intermediary device is mounted; and
setting the identification information based on the position information.

10. The computer-readable recording medium according to claim 9, wherein
the acquiring and the setting are performed in the intermediary device,
the acquiring includes acquiring the position information indicating a position at which the intermediary device itself is mounted, and
the setting includes setting the position information at which the intermediary device itself is mounted based on the identification information of the intermediary device itself.

11. The method according to claim 9, wherein
a plurality of intermediary devices are mounted on the substrate, and
the identification information includes information on an order of an arrangement of the intermediary devices.

12. The method according to claim 9, wherein
the position information is represented by a first number, and
the setting includes setting a second number that is obtained by adding one to the first number as the identification information.
